(19) United States
(12) Patent Application Publication
(10) Pub. No.: US 2010/0093276 A1
(43) Pub. Date: Apr. 15, 2010

(54) SEMICONDUCTOR DEVICE

(75) Inventor: Peter Muhmenthaler, Hohenbrunn (DE)

Correspondence Address: DICKE, BILLIG & CZAJA, FIFTH STREET TOWERS, 100 SOUTH FIFTH STREET, SUITE 2250, MINNEAPOLIS, MN, 55402, US

(73) Assignee: Infineon Technologies AG, Neubiberg (DE)

(21) Appl. No.: 12/251,987

(22) Filed: Oct. 15, 2008

(51) Int. Cl. H04B 7/24

(52) U.S. Cl. 455/39

(57) ABSTRACT

A semiconductor device includes a radio frequency circuit and a programmable logic circuit electrically coupled to the radio frequency circuit.

### BACKGROUND

Wireless communication systems are used in a wide variety of applications, such as cellular phones, personal digital assistants, game systems, digital music players, electronic book readers, remote controls, wireless headsets, network devices, and other electronic devices. Wireless communication systems are typically fabricated using multiple separate components, such as transceivers, power amplifiers, digital signal processors, etc.

For these and other reasons, there is a need for the present invention.

### SUMMARY

One embodiment provides a semiconductor device. The semiconductor device includes a radio frequency circuit and a programmable logic circuit electrically coupled to the radio frequency circuit.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 is a diagram illustrating one embodiment of a semiconductor device.

FIG. 2 is a diagram illustrating another embodiment of a semiconductor device.

FIG. 3 is a diagram illustrating one embodiment of a system.

FIG. 4 is a diagram illustrating another embodiment of a system.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

It is to be understood that the features of the various exemplary embodiments described herein may be combined with each other, unless specifically noted otherwise.

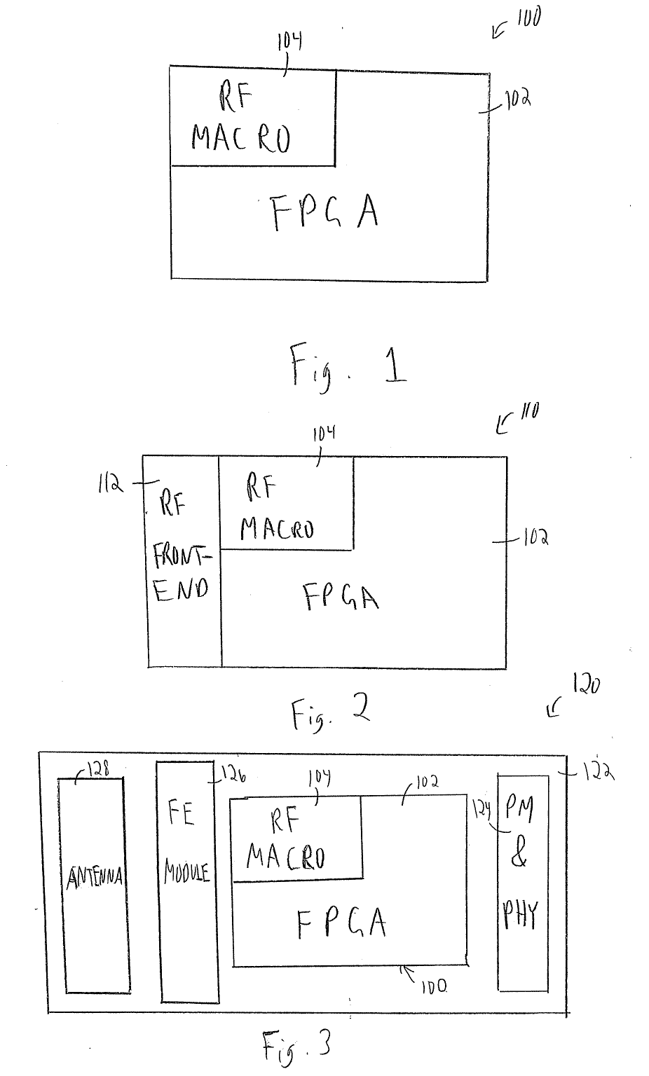

FIG. 1 is a diagram illustrating one embodiment of a semiconductor device 100. Semiconductor device 100 includes a Field Programmable Gate Array (FPGA) 102 or another suitable programmable logic circuit and a Radio Frequency (RF) macro 104. In one embodiment, FPGA 102 and RF macro 104 are integrated on a single semiconductor substrate, such as a silicon substrate or another suitable semiconductor substrate. In another embodiment, FPGA 102 and RF macro 104 are integrated on separate semiconductor substrates and then combined into a single System in Package (SiP) or Multi-Chip Package (MCP). RF macro 104 is communicatively coupled to FPGA 102. Semiconductor device 100 provides an area optimized and flexible realization (due to FPGA 102) wireless signal transmission and processing system.

RF macro 104 provides optimized RF transceiver functions for one or more communication protocols. The communication protocols can be in license free Industrial, Scientific, and Medical (ISM) bands, such as Bluetooth, Wireless Local Area Network (WLAN), or ZigBee, or in authority regulated bands, such as Global System for Mobile applications (GSM), General Packet Radio Service (GPRS), Code Division Multiple Access (CDMA), Evolution-Data Optimized (EV-DO), Enhanced Data rates for GSM Evolution (EDGE), Digital Enhanced Cordless Telecommunications (DECT), Digital AMPS (IS-136/TDMA), Integrated Digital Enhanced Network (iDEN), or other suitable communication protocol.

FPGA 102 provides programmable logic that offers system designers freedom for designing digital functions in a single package that already includes built-in RF transceiver functions. Therefore, the system designer can focus on designing the digital functions and not have to design the radio frequency transceiver functions as well. By including FPGA 102, the digital function of semiconductor device 100 can be programmed for use in any one of a wide variety of applications, such as cellular phones, personal digital assistants, game systems, digital music players, electronic book readers, remote controls, wireless headsets, network devices, or other suitable electronic devices.

FIG. 2 is a diagram illustrating another embodiment of a semiconductor device 110. Semiconductor device 110 is similar to semiconductor device 100 previously described and illustrated with reference to FIG. 1, except that semiconductor device 110 also includes RF front-end 112. In one embodiment, FPGA 102, RF macro 104, and RF front-end 112 are integrated on a single semiconductor substrate, such as a silicon substrate or another suitable semiconductor substrate. In another embodiment, FPGA 102, RF macro 104, and RF front-end 112 are integrated on two or three separate semiconductor substrates and then combined into a single SiP or MCP.

RF front-end 112 is communicatively coupled to RF macro 104. RF front-end 112 includes amplifiers, an antenna switch, and/or other suitable circuits for transmitting and receiving RF signals. RF front-end 112 receives signals from RF macro 104 to pass to an external antenna (not shown) for transmission over the air. RF front-end 112 receives signals from the external antenna that were received from over the air to pass to RF macro 104.

FIG. 3 is a diagram illustrating one embodiment of a system 120. In one embodiment, system 120 includes semiconductor device 100 previously described and illustrated with reference to FIG. 1, a power management and physical layer (PM & PHY) circuit 124, a front-end (FE) module 126, and an antenna 128. In another embodiment, semiconductor device 100 and front-end module 126 are replaced with semiconductor device 110 previously described and illustrated with reference to FIG. 2. Semiconductor device 100, power management and physical layer circuit 124, front-end module 126, and antenna 128 are mounted on a printed circuit board (PCB) 122 or another suitable substrate. Printed circuit board 122 routes power and data signals between semiconductor device 100, power management and physical layer circuit 124, front-end module 126, and antenna 128.

Front-end module 126 passes signals between RF macro 104 and antenna 128. Front-end module 126 provides a similar function as RF front-end 112 previously described and illustrated with reference to FIG. 2. Antenna 128 receives signals from over the air and passes the signals to front-end module 126. Antenna 128 receives signals from front-end module 126 and transmits the signals over the air. Power management and physical layer circuit 124 provides voltage and/or current regulation and a physical layer of a communication interface for system 120. In one embodiment, the communication interface includes a high speed interface, such as Universal Serial Bus (USB), FireWire, Peripheral Component Interconnect Express (PCI-E), Ethernet, or other suitable communication interface.

In one embodiment, system 120 provides a radio frequency certified printed circuit board module that can be used by system developers for a wide variety of applications. System 120 allows system developers to focus on designing the digital functions of the system and not have to design the radio frequency transceiver functions as well. The radio frequency functions of system 120 provided by RF macro 104, front-end module 126, and antenna 128 are provided preconfigured and optimized for operation with FPGA 102.

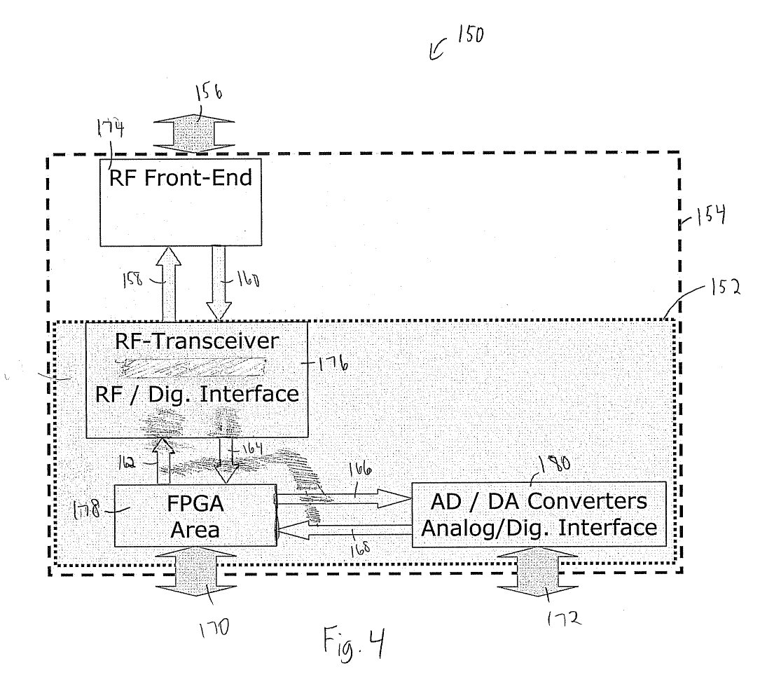

FIG. 4 is a diagram illustrating another embodiment of a system 150. System 150 includes RF front-end 174, RF-transceiver and RF/digital interface circuit 176, FPGA area 178, and Analog-to-Digital (AD)/Digital-to-Analog (DA) converters and analog/digital interface 180. In one embodiment, RF-transceiver and RF/digital interface circuit 176, FPGA area 178, and AD/DA converters and analog/digital interface 180 are integrated on a first semiconductor substrate 152 and RF front-end 174 is integrated on a second semiconductor substrate. In another embodiment, RF front-end 174, RF-transceiver and RF/digital interface circuit 176, FPGA area 178, and AD/DA converters and analog/digital interface 180 are integrated on a single integrated circuit 154.

RF front-end 174 communicates with an external circuit through signal path 156. In one embodiment, RF front-end 174 is electrically coupled to an antenna (not shown) through signal path 156 for transmitting and receiving signals over the air. RF front-end 174 is communicatively coupled to RF-transceiver and RF/digital interface 176 through communication links 158 and 160. In one embodiment, communication link 158 includes multiple radio frequency channels for passing signals from RF-transceiver and RF/digital interface 176 to RF front-end 174. In one embodiment, communication link 160 includes multiple radio frequency channels for passing signals from RF front-end 174 to RF-transceiver and RF/digital interface 176.

RF-transceiver and RF/digital interface 176 is communicatively coupled to FPGA area 178 through communication links 162 and 164. In one embodiment, communication link 162 includes multiple digital signal lines for passing signals from FPGA area 178 to RF-transceiver and RF/digital interface 176. In one embodiment, communication link 164 includes multiple digital signal lines for passing signals from RF-transceiver and RF/digital interface 176 to FPGA area 178.

FPGA area 178 is communicatively coupled to AD/DA converters and analog/digital interface 180 through communication links 166 and 168. In one embodiment, communication link 166 includes multiple digital signal lines for passing signals from FPGA area 178 to AD/DA converters and analog/digital interface 180. In one embodiment, communication link 168 includes multiple digital signal lines for passing signals from AD/DA converters and analog/digital interface 180 to FPGA area 178. FPGA area 178 communicates with an external circuit through signal path 170. In one embodiment, FPGA area 178 is programmed through signal path 170. AD/DA converters and analog/digital interface 180 communicates with an external circuit through signal path 172. In one embodiment, AD/DA converters and analog/digital interface 180 passes signals to an external circuit and receives signals from an external circuit through signal path 172 for operating system 150.

RF front-end 174 operates similarly to RF front-end 112 previously described and illustrated with reference to FIG. 2. RF-transceiver and RF/digital interface 176 operates similarly to RF macro 104 previously described and illustrated with reference to FIG. 1. FPGA area 178 operates similarly to FPGA 102 previously described and illustrated with reference to FIG. 1. AD/DA converters and analog/digital interface 180 converts analog signals to digital signals and/or converts digital signals to analog signals. In addition, AD/DA converters and analog/digital interface 180 provides an analog and/or digital interface between system 150 and an external circuit.

System 150 allows system developers to focus on designing the digital functions of the system and not have to design the radio frequency transceiver functions as well. The radio frequency functions of system 150 provided by RF front-end 174 and RF-transceiver and RF/digital interface 176 are provided preconfigured and optimized for operation with FPGA area 178 and AD/DA converters and analog/digital interface 180.

Embodiments provide semiconductor devices including a radio frequency circuit and a programmable logic circuit. In one embodiment, the radio frequency circuit and the programmable logic circuit are integrated on a single semiconductor substrate or chip. In another embodiment, the radio frequency circuit and the programmable logic circuit are integrated on separate semiconductor substrates or chips and then combined into a single package. The programmable logic circuit allows a system designer to program the semiconductor device for use in any one of a wide variety of wireless communication applications using a preconfigured and optimized radio frequency circuit. Therefore, a single chip based, flexible communication system is provided that reduces the number of components and the cost of the system compared to typical multiple component solutions.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A semiconductor device comprising:
a radio frequency circuit; and
a programmable logic circuit electrically coupled to the radio frequency circuit.

2. The semiconductor device of claim 1, wherein the radio frequency circuit and the programmable logic circuit are integrated on one chip.

3. The semiconductor device of claim 1, wherein the radio frequency circuit comprises one of a Bluetooth circuit, a wireless local area network (WLAN) circuit, a global system for mobile communications (GSM) circuit, and a ZigBee circuit.

4. The semiconductor device of claim 1, further comprising:
a radio frequency front-end circuit electrically coupled to the radio frequency circuit.

5. The semiconductor device of claim 4, wherein the radio frequency circuit, the programmable logic circuit, and the radio frequency front-end circuit are integrated on one chip.

6. The semiconductor device of claim 4, further comprising:
an antenna electrically coupled to the radio frequency front-end circuit.

7. The semiconductor device of claim 4, further comprising:
a power management unit and physical layer electrically coupled to the programmable logic circuit.

8. The semiconductor device of claim 1, wherein the programmable logic circuit comprises a field programmable gate array circuit.

9. A semiconductor device comprising:
a radio frequency component; and
a field programmable gate array component electrically coupled to the radio frequency component,
wherein the radio frequency component and the field programmable gate array component are integrated on a single semiconductor substrate.

10. The semiconductor device of claim 9, wherein the radio frequency component comprises one of a Bluetooth component, a wireless local area network (WLAN) component, a global system for mobile communications (GSM) component, and a ZigBee component.

11. The semiconductor device of claim 9, further comprising:
a radio frequency front-end component electrically coupled to the radio frequency component.

12. The semiconductor device of claim 11, wherein the radio frequency component, the field programmable gate array component, and the radio frequency front-end component are integrated on a single semiconductor substrate.

13. The semiconductor device of claim 11, further comprising:
an antenna electrically coupled to the radio frequency front-end component.

14. A method for fabricating a semiconductor device, the method comprising:
providing a radio frequency circuit; and
providing a programmable logic circuit electrically coupled to the radio frequency circuit.

15. The method of claim 14, wherein providing the radio frequency circuit and the programmable logic circuit comprises fabricating the radio frequency circuit and the programmable logic circuit on one chip.

16. The method of claim 14, wherein providing the radio frequency circuit comprises providing one of a Bluetooth circuit, a wireless local area network (WLAN) circuit, a global system for mobile communications (GSM) circuit, and a ZigBee circuit.

17. The method of claim 14, further comprising:
providing a radio frequency front-end circuit electrically coupled to the radio frequency circuit.

18. The method of claim 17, wherein providing the radio frequency circuit, the programmable logic circuit, and the radio frequency front-end circuit comprises fabricating the radio frequency circuit, the programmable logic circuit, and the radio frequency front-end circuit on one chip.

19. The method of claim 17, further comprising:
providing an antenna electrically coupled to the radio frequency front-end circuit.

20. The method of claim 14, wherein providing the programmable logic circuit comprises providing a field programmable gate array circuit.

21. A method for fabricating a semiconductor device, the method comprising:
fabricating a radio frequency component on a semiconductor substrate; and
fabricating a field programmable gate array component electrically coupled to the radio frequency component on the semiconductor substrate.

22. The method of claim 21, wherein fabricating the radio frequency component comprises fabricating one of a Bluetooth component, a wireless local area network (WLAN) component, a global system for mobile communications (GSM) component, and a ZigBee component.

23. The method of claim 21, further comprising:
fabricating a radio frequency front-end component electrically coupled to the radio frequency component on the semiconductor substrate.

24. The method of claim 23, further comprising:
providing an antenna electrically coupled to the radio frequency front-end component.

25. The method of claim 23, further comprising:
providing a power management unit and physical layer electrically coupled to the field programmable gate array component.
